(19) United States
(12) Patent Application Publication
(10) Pub. No.: US 2020/0018865 A1
(43) Pub. Date: Jan. 16, 2020

(54) IMAGE PROCESSING WITH IMPROVED RESOLUTION ISOTROPY

(71) Applicant: MOLECULAR DYNAMICS LIMITED, Hamilton (BM)

(72) Inventors: Tal KENIG, Avihayil (IL); Zvi DEVIR, Haifa (IL)

(73) Assignee: MOLECULAR DYNAMICS LIMITED, Hamilton (BM)

(21) Appl. No.: 16/485,657

(22) PCT Filed: Feb. 13, 2018
(86) PCT No.: PCT/IL2018/050165

§ 371 Date: Aug. 13, 2019

Related U.S. Application Data
(60) Provisional application No. 62/458,024, filed on Feb. 13, 2017.

(51) Int. Cl. G01T 1/24

(52) U.S. Cl. CPC G01T 1/249; G01T 1/1614; G01T 1/247

(57) ABSTRACT

A method of processing a SPECT image of a region of interest is disclosed. The SPECT image was obtained using at least one gamma detector detecting gamma radiation from the region of interest at multiple detector configurations, and the method includes: obtaining data indicative of the detector configurations and their spatial relationships to the region of interest; determining a resolution level for each of a plurality of directions in each point in the image based on the data obtained; and processing the image based on the resolution levels determined.

### FIELD OF THE INVENTION

The present disclosure is in the field of imaging by gamma radiation, and more particularly, but not exclusively, in the field of single photon emission computerized tomography (SPECT).

### BACKGROUND OF THE INVENTION

In traditional SPECT imaging, a large gamma detector, weighing typically about 500 kg, and having about half a meter in diameter or diagonal, is brought near a patient for detecting gamma photons emitted from the patient (who before was injected with a gamma emitting material, also known as radiopharmaceutical). This large and heavy gamma detector collects gamma photons for some time, and then moves to another position, for detecting gamma photons from a different side of the patient's body.

Recently, smaller and lighter gamma detectors have become commercially available, usually based on Cadmium Zinc Telluride (CZT) crystals.

### SUMMARY OF THE INVENTION

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider.

Some embodiments of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer, and may not be feasible or practical for performing purely manually, by a human expert. A human expert who wanted to manually perform similar tasks, such as measuring dielectric properties of a tissue might be expected to use completely different methods, e.g., making use of expert knowledge and/or the pattern recognition capabilities of the human brain, which would be vastly more efficient than manually going through the steps of the methods described herein.

An aspect of some embodiments of the invention includes a method of processing a SPECT image of a region of interest obtained using at least one gamma detector detecting gamma radiation from the region of interest at multiple detector configurations. In some embodiments, the method includes:

obtaining data indicative of the detector configurations and their spatial relationships to the region of interest;

determining a resolution level for each of a plurality of directions in each point in the image based on the data obtained; and

processing the image based on the resolution levels determined.

In some embodiments, the data is further indicative of multiple detection durations, each associated with at least one of the detector configurations, and wherein the resolution levels are determined based on said durations.

In some embodiments, the resolution levels are described by an estimated point spread function (PSF) at each point location.

In some embodiments, different resolution levels are determined along different directions for at least one point. In some such embodiments, the data is further indicative of the shape of the region of interest, and the resolution levels are determined based on said shape.

In some embodiments, the processing comprises reducing the variability of a point resolution along different directions.

In some embodiments, the processing comprises reducing the variability of a direction resolution among different points and/or reducing the variability of local resolutions along different points in the image.

In some embodiments, processing the image comprises reducing the resolution in a first direction of a point having in the first direction a resolution level higher than in a second direction.

In some embodiments, the method includes denoising and/or sharpening the image based on the resolution levels determined.

In some embodiments, the method includes reducing the resolution in some points and/or directions and sharpening the image in other points and/or directions

An aspect of some embodiments of the invention includes a method of reconstructing a SPECT image of a region of interest obtained using at least one gamma detector detecting gamma radiation from the region of interest at multiple detector configurations. In some embodiments, the method includes:

obtaining data indicative of the detector configurations and their spatial relationships to the region of interest;

determining a resolution level for each of a plurality of directions in each point in the image to be reconstructed based on the data obtained; and

reconstructing the image based on the resolution levels determined.

In some embodiments, the reconstructing comprises imposing a regularization prior for each point based on the resolution levels. In some such embodiments, the regularization prior is imposed between reconstruction iterations or sub-iterations.

In some embodiments, the data is further indicative of multiple detection durations, each associated with at least one of the detector configurations, and wherein the resolution levels are determined based on said durations.

In some embodiments, the data is further indicative of the shape of the region of interest, and the resolution levels are determined based on said shape.

In some embodiments, the reconstruction method includes reconstructing the data so that the variability of a point resolution along different directions, and/or the variability of a direction resolution among different points, is reduced.

In some embodiments, reconstructing the image comprises reconstructing to reduce the resolution along a first direction of a point having a higher resolution level in the first direction than in a second direction.

In some embodiments, the method includes denoising and/or sharpening the image based on the resolution levels determined.

An aspect of some embodiments of the invention includes an apparatus for imaging a region of interest, the apparatus comprising:

at least one gamma detector;

a detection controller configured to control the at least one gamma detector to detect gamma radiation from the region of interest at multiple detector configurations; and

a processor. The processor is configured to:
reconstruct an image from readings of the at least one gamma detector;
obtain data indicative of the multiple detector configurations and their spatial relationships to the region of interest;
determine a resolution level for each of a plurality of directions in each point in the image based on the data obtained; and
process the image based on the resolution levels determined.

In some embodiments, the detection controller is configured to control the at least one gamma detector to detect gamma radiation from the region of interest for a different time duration at each of the multiple detector configurations, and the resolution levels are determined based on said time durations.

In some embodiments, the data is further indicative of the shape of the region of interest, and the resolution levels are determined based on said shape.

In some embodiments, the apparatus also includes at least one 3D sensor, and the processor is configured to infer the shape of the region from readings of the at least one 3D sensor. In some such embodiments, the resolution levels are determined based on said shape.

In some embodiments, the processor is configured to process the image so that a variability of a point resolution along different directions and/or a variability of a direction resolution among different points, are reduced.

In some embodiments, the processor is configured to process the image by reducing the resolution of a point along the first direction for points having a resolution level higher in the first direction than in a second direction.

In some embodiments, the processor is configured to reconstruct a denoised and/or sharpened image based on the resolution levels determined.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a diagrammatic presentation of an apparatus for scanning a region of interest (ROI);

FIG. 2A is a cross-sectional illustration of a detection head according to some embodiments of the invention;

FIG. 2B is a cross-sectional illustration of the detector shown in FIG. 2A along a cross-section perpendicular to that depicted in FIG. 2A;

FIGS. 3A, 3B, and 3C illustrate how the resolution in SPECT may be dominated by the distance from the collimator, the collimator's geometry, and the swivel angle;

FIG. 4 is a copy of a SPECT image taken from a Jaszczak SPECT Phantom by a system similar to that illustrated in FIG. 1, but without correcting the local resolutions as taught herein;

FIG. 5 is an illustration of a resolution estimation process according to some embodiments of the invention; and

FIG. 6A is a SPECT image of a brain taken by a system as illustrated in FIG. 1, but without correcting for resolution variability; and

FIG. 6B is the SPECT image shown in FIG. 6A after further processing for correcting for resolution variability according to embodiments of the present invention.

### DETAILED DESCRIPTION

An aspect of some embodiments of the invention includes a method of processing a SPECT image of a region of interest. According to some embodiments, the SPECT image to be processed is obtained using at least one gamma detector detecting gamma radiation that emerges from the region of interest. Each detector (or least at one of the detectors) detects the gamma radiation when at multiple detector configurations.

As used herein, a detector configuration is defined by the spatial relation between the detector and the body of the patient. In some embodiments, the spatial relationship may be defined by a first spatial relationship defined between the detector and some coordinate system, and a second spatial relationship defined between the region of interest and said coordinate system. This way or the other, the spatial relationship may be defined by one or more configuration describing parameters. For example, in some embodiments, the gamma detector is mounted on an extendable arm, that can extend towards and away of the patient. The distance from the patient may form part of the gamma detector configuration and may be considered a configuration describing parameter. Similarly, the extent to which the extendable arm is extended may form part of the gamma detector configuration and may be considered a configuration describing parameter. In some embodiments, the extendable arm is supported on a gantry that may be rotated around the patient to various angles. The gantry angle may form part of the gamma detector configuration and may be considered a configuration describing parameter. In some embodiments, even in the absence of a revolving gantry, the gamma detector may be positioned in different angles in respect to the patient, e.g., facing the nose, facing the left ear, etc. In some embodiments, these facing angles may form part of the gamma detector configuration and may be considered a configuration describing parameter. In some embodiments, the gamma detector is mounted on the extendable arm so the detector can swivel with respect to the arm. The swivel angle may also form a part of the detector configuration. In some embodiments, the gamma detector configuration may be represented by a vector, the different components of which represent different configuration describing parameters, for example, gantry angle, swivel angle, distance from the patient, etc.

In some embodiments, the method comprises obtaining data indicative of the detector configurations used during imaging. For example, the obtained data may associate each detector with distances, gantry angles and swivel angles, from which the detector has detected gamma radiation for generating the image to be processed. In some embodiments, the data may further include time periods, for the length of which each detector dwelled at a respective detector configuration for detecting gamma radiation. In some embodiments, the obtained data may be further indicative of detection durations, each associated with at least one of the detector configurations at which radiation was detected to generate the image to be processed. Optionally, the data obtained also associates each detector with data indicative of characterizations of the detector itself, e.g., the structure of the detector's collimator.

In some embodiments, the method comprises determining for each point in the image a local resolution indicator based on the obtained data. As used herein, a local resolution indicator includes a resolution level for each of a plurality of directions at the respective point in the image. For example, the method may include determining for each point a point spread function based on the obtained data. In some embodiments, determining the local resolution indicators comprises determining, for each point, a positive definite matrix that can be diagonalized so that each eigenvector represents a direction, and the eigenvalue associated with the eighenvector is the resolution along the represented direction.

The resolution at a point may be described by local resolution at a main direction, and local resolutions at directions perpendicular to the main direction. In some embodiments, the resolution at a point is described by a positive definite matrix. This matrix has the local resolutions as its eigenvalues, which correspond to the local resolutions along the directions of the corresponding eigenvectors.

Finally, the image may be processed based on the local resolution indicators determined. For example, the image may be filtered to reduce resolution levels where these exceed a threshold resolution level. The threshold resolution level may be predefined. In some embodiments, the threshold resolution level may be determined based on the resolution levels determined, e.g., so that a predetermined portion of the levels (e.g., 10%, 20%, 50%, etc.) of the local resolutions are reduced.

In some embodiments, processing the image based on the determined resolution levels may include reducing the variability of the resolution at a given point along different directions. In some embodiments, the processing may include reducing the variability of the resolution along different directions at each point where said variability is above a threshold. The threshold may be determined in advance (e.g., reducing the variability at every point where the variability is above a certain value). Optionally, the threshold may be determined as a portion of the average resolution at the given point, for example, in some embodiments, the resolution is reduced if the variability is larger than 10%, 20%, 50%, etc. of the average resolution at the point. The variability may be defined, for example, as a standard deviation of the resolutions. In some embodiments, processing the image based on the resolution values determined may include reducing the variability in resolution along a given direction, for example, processing the image so that the resolution along a given direction will never exceed a threshold. In another example, the resolution along a direction may be reduced only for some points, where at other points the resolution may be left unchanged or increased, while the overall variability in resolution decreases. In some embodiments, processing the image based on the resolution values may include reducing the between-points variability in average resolution.

Reducing variability in resolution may include reducing the resolution at a point in a first direction where the resolution level along said first direction is higher than along a second direction.

In some embodiments, processing the image may include denoising the image based on the resolution levels determined. In some embodiments, denoising may be achieved by filtering the image, linearly or non-linearly. The extent of filtering may be different at different points and directions, based on the resolution at these points or along these directions. For example, when it is assumed the noise is characterized by high frequencies, (i.e., where the resolution is high) filtering can be reduced or not carried out at all at points and along low resolution directions.

A broad aspect of some embodiments of the invention includes reconstructing a SPECT image of a region of interest from data obtained using at least one gamma detector detecting gamma radiation from the region of interest at multiple detector configurations.

The reconstruction method is similar to the processing method in that it relies on data indicative of the detector configurations and the spatial relationships indicated thereby, and determination of resolution levels based on the data. However, the denoising, reduction in resolution variability, or any other effect described above, is achieved during the reconstruction of the image, rather than first reconstructing the image, and then manipulating the reconstructed image as described above. For example, during reconstruction, the resolution levels may be used to impose a regularization prior for each point in the image.

In some embodiments, a mathematical filter may be constructed to account for the differences in the resolutions. In some embodiments, this filter may be applied to the reconstructed image. An exemplary way to construct the filter may include the following steps: first, one can define a first filter that reduces the resolution of a theoretical image to the resolution of the real image at hand. Then, a second filter is searched for, that when applied together with the first, will result in uniform, as high as possible, resolution. Mathematically this may require finding a filter having small eigenvalues (because the higher are the eigenvalues, the lower is the resolution) that are not too different from each other, and that changes minimally across the image.

In some embodiments, the filter may be used during the image reconstruction. For example, the reconstruction may be carried out using an iterative method, where in each iteration step the image of the preceding step is point-wise multiplied by or added to an advancement term. In some embodiments, a filter constructed to account for the variable resolution may be applied to the advancement term, so that at each iteration step the filter is applied. In some embodiments, the degree of filtering may be controlled by carrying out each iteration step twice: once with the filter and once without the filter, and then averaging the two results, optionally by non-equally weighted average. For example, to filter rather strongly, the weight of the filtered image may be 70% and the weight of the non-filtered image may be 30%. To filter much less strongly, the weight of the filtered image may be 25% and the weight of the non-filtered image may be 75%.

An aspect of some embodiments of the invention comprises an apparatus for imaging a region of interest, e.g., by SPECT. The apparatus may include at least one gamma detector; a detection controller, and a processor. The detection controller may be configured to control the at least one gamma detector to detect gamma radiation from the region of interest at multiple detector configurations, for example, at multiple swivel angles, multiple gantry angles, etc.

The processor may be configured to reconstruct an image from readings of the at least one gamma detector. For this end, the processor may be configured to obtain data indicative of the multiple detector configurations at which the readings were obtained (or are to be obtained), and based on the obtained data, determine a resolution level expected for each of a plurality of directions in each point in the image. The processor may be further configured to reconstruct the image based on the resolution levels determined. In some embodiments, the processor may be configured to process an already reconstructed image based on the obtained data.

In some embodiments, the detection controller is configured to control the at least one gamma detector to detect gamma radiation from the region of interest for a different time duration at each of the multiple detector configurations. In some such embodiments, these time durations are taken into consideration for the determination of the resolution levels. For example, a point in the region of interest that is imaged by a detector at a certain detector configuration can have higher resolution as longer detection results in lower noise, which allows achieving better resolution.

In some embodiments, data obtained by the processor may include data indicative of the shape of the region of interest, and the resolution levels are determined based on said shape. For example, the shape may be used to determine the spatial relation between the detector and the region of interest (or between the detector and any given portion of the region of interest) based on data indicative of the position and orientation of the detector in a given coordinate system, and data indicative of the shape and position of the region of interest, e.g., in the same coordinate system.

In some embodiments, the apparatus may include at least one 3D sensor. The 3D sensor may provide data indicative of the outer shape of the region of interest, and the processor may be configured to infer the shape of the region of interest from these data.

In some embodiments, the processor is configured to process the image and/or to reconstruct the image so that a variability of a point resolution along different directions, and/or variability of a direction resolution among different points is reduced. For example, when a point has a higher resolution in a given direction in comparison to the resolution of the same point in other directions, the processor may be configured to process the image by reducing the resolution of that point along the said certain direction.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

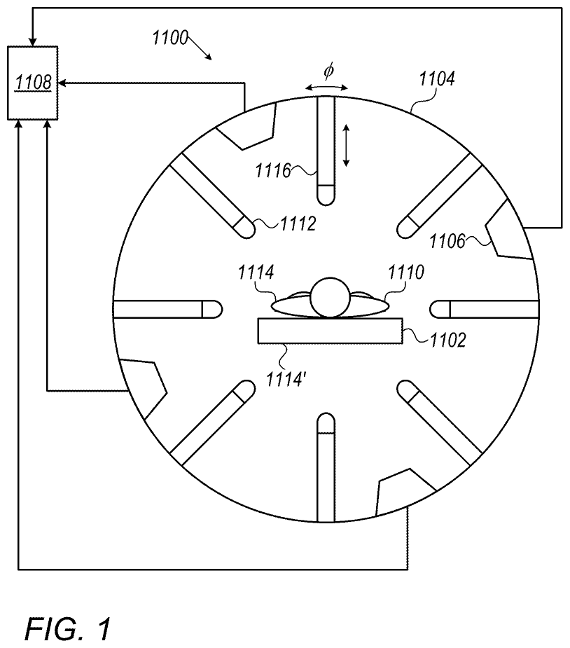

FIG. 1 is a diagrammatic presentation of an apparatus 1100 for scanning a region of interest (ROI). Apparatus 1100 includes, inter alia, a support (1102), a gantry (1104), 4 3D sensors 1106, and a processor (1108).

Support 1102 is configured to support patient 1110 during imaging. The patient support may be configured to support lying patients, as illustrated. In some embodiments, the patient support may be configured to support standing patients, sitting patients, and/or leaning patients. For example, the support may be horizontal, such as a patient bed, vertical, such as a wall or a back of a chair and the like. The support may be made of low attenuation material, for refraining from attenuating gamma radiation emanating from the patient towards the detectors on the other side of the support.

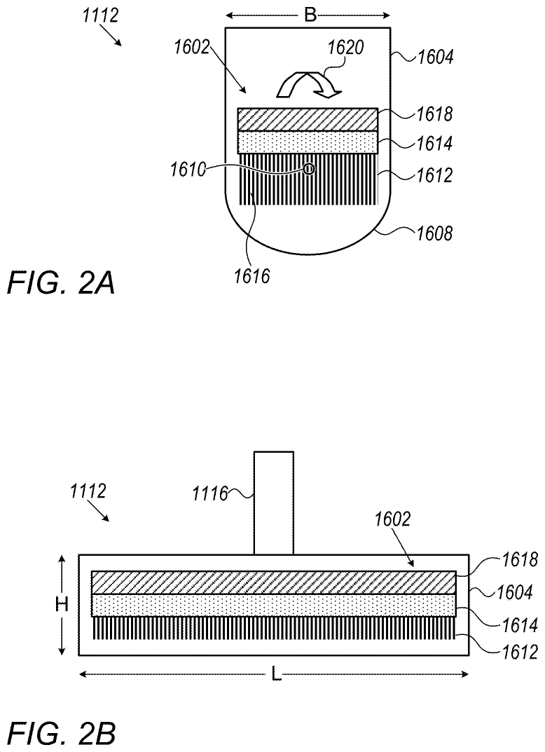

Gantry 1104 includes a cylindrical frame that supports multiple detection heads 1112, each including a gamma detector, not shown in the present figure. In some embodiments, each gamma detector faces support 102. An example of a gamma detector is described below in relation to FIG. 2A and FIG. 2B. Each detection head 1112 may be mounted on an extendable arm 1116, configured to take the gamma detector mounted on it in a linear in-out movement, so as to bring the detector closer to the patient or away of it. Gantry 1104 is rotatable around an axis, along, for example, angle ϕ), to allow the gamma detectors to rotate around the support.

Each detection head 1112 may include a semiconductor detecting crystal, for example cadmium zinc telluride (CZT) detecting crystal. A linear actuator is provided to linearly maneuver extendable arm 1116 so that detection head 1112 moves toward and from patient support 1102. Optionally, the linear actuator is mechanical actuator that converts rotary motion of a control knob into linear displacement, a hydraulic actuator or hydraulic cylinder, for example a hollow cylinder having a piston, a piezoelectric actuator having a voltage dependent expandable unit, and/or an electro-mechanical actuator that is based on an electric motor, such a stepper motor and the like. In some embodiments, the linear actuator may include a stepper motor and a sensor, optionally a magnetic sensor (e.g., encoder) that senses the actual position of detection head 1112, to provide feedback on the control of the stepper motor. The control of each linear actuator may be performed according to a scanning plan. In some embodiments, the scanning plan may be generated by processor 1108. The scanning plan may include, for example, a list of detector configurations for each of the detectors, and a time to dwell at each configuration. A configuration may be defined, for example, by angle of gantry 1104, the extension of extendable arm 1116, and a swiveling angle of the gamma detectors in detection heads 1112 (see FIG. 2C).

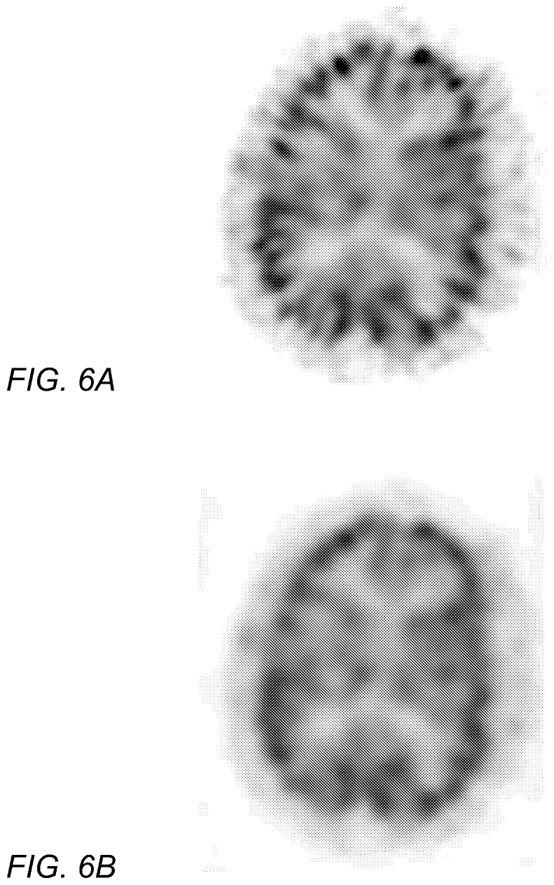

Each sensor 1106 is a 3D sensor arranged to sense a portion of patient 1110 when the patient is supported by support 1102. These optional sensors may provide data to delimit the region of interest, and this data may be used in determining the spatial relation between a gamma detector 1112 and the region of interest. Sensor 1106 may be, for example, optical, ultrasonic, or based on radio waves or microwaves. Examples of specific technologies used in such sensors are structured light sensors, illumination assisted stereo sensors, passive stereo sensors, radar sensors, Lidar sensors, and time of flight sensors. Commercially available embodiments of such sensors include Microsoft Kinect, Intel RealSense Camera F200, Mantis Vision's 3D scanners, PMD technologies PicoFlexx, and Vayyar Imaging Walabot. Sensor 1106 is configured to output signals indicative of 3D coordinates of points (e.g., point 1114, 1114′) on an outer surface of patient 1110 and/or support 1102. In some embodiments, the 3D sensor(s) provides a point cloud that allows approximating the outer surface of the bed and/or patient. In some embodiments, the 3D sensor may be installed on the gantry, as shown in FIG. 6. Alternatively or additionally, one or more 3D sensors may be installed on the extendable arm 1116, inside detection head 1112, on a separate support structure, or at any other location, at which the one or more 3D sensors can sense the position of at least one point of the outer surface of the patient and/or support.

Processor 1108 may be configured to determine for each point in the region of interest, a respective local resolution based on the scanning plan, and particularly on the positions from which the point is to be scanned.

As used herein, if a machine (e.g., a processor) is described as “configured to” perform a particular task (e.g., determine weights), then the machine includes components, parts, or aspects (e.g., software) that enable the machine to perform the particular task. In some embodiments, the machine may perform this task during operation.

FIG. 2A is a cross-sectional illustration of a detection head 1112 according to some embodiments of the invention. Detection head 1112 has a breadth B, length L and height H (see FIG. 2B for the length L and height H). Detection head 1112 may include a detecting unit 1602 in a housing 1604. For example, the detecting units 1602 may be housed to protect patient 1110 from swivel motion (illustrated by the arrow 1620) of the detecting unit 1602. Housing 1604 may have a round or curved cover. In some embodiments, housing 1604 includes a cover shaped with a section 1608 of a cylinder that allows for the swivel of the detecting unit 1602 around a swiveling axis 1610. Detection head 1112 is shown to include a parallel hole collimator 1612. Such a collimator may be used to gain information about the direction from which each photon arrives at the detection layer 1614. Collimator 1612 may include thin walls 1616 (also referred to as septa) that define channels parallel to each other. The walls may be made of materials that have high linear attenuation coefficient for gamma radiation, such as lead or tungsten. Each photon may be considered to arrive to a point where it hits detection layer 1614 through a channel of the collimator. Most of the photons that hit septa 1616 are absorbed by the septa, so that mainly photons that go nearly perpendicularly to detection layer 1614 reach the detection layer. The near perpendicularity may be expressed as a solid angle, from which the photons have to emerge in order to have a high probability (e.g., larger than 90%) to reach the detection layer. Detecting unit 1602 may also include heat sink 1618, which may be attached to the detection layer on the detection layer side free of collimator 1612. Detection head 1112 may also include electronics (not shown) for transferring data to and from the detection layer to processor 1108.

While the explanations above refer to a collimator known in the field as a parallel hole collimator, one or more of collimators 1612 may be of a different kind, for example, a pinhole collimator, a slant hole collimator, or a fan beam collimator (e.g., a converging collimator, or a diverging collimator). In some embodiments, different detectors 1112 may include collimators of different kinds.

Detection head 1112 may include further parts, as well known in the field. For example, the detection layer 1614 may include a plurality of detection modules, and each may have its own ASIC. The gamma detector may further include a carrier board which holds all of the detection modules, and interfaces to the ASICs. The gamma detector may also include shielding from external radiation, and additional mechanics to hold the detection layer, ASICs, electronics, cover, etc., together. The gamma detector may also include a swivel motor, a swivel axis, belt, tensioners, encoder for encoding the exact swivel angle, electronic boards to control the motion of the detector with the gamma detector and/or inside the gamma detector, and electronic boards to transfer data indicative of the photons received at the detection layer.

FIG. 2B is a cross-sectional illustration of the detector shown in FIG. 2A along a cross-section perpendicular to that depicted in FIG. 2A. FIG. 2B illustrates that in some embodiments detector 1112 may be elongated, for example, to almost contact with the patient along a line parallel to the longitudinal axis of the patient. The length of the detector may be sufficient to allow acquiring the entire scan without moving the patient (or the gantry) along the patient, and yet short enough to allow maximal proximity between the detector and the patient taking into account body curvatures. A length of about 30 cm to 40 cm is found to be satisfactory for imaging grown up humans. FIG. 1 also shows extendable arm 1116. In some embodiments, the angle between extendable arm 1116 and detector 1112 is fixed, e.g., as 90°. In some embodiments, the angle between extendable arm 1116 and detector 1112 may be controllable, e.g., by processor 1108. In some embodiments, the length of detector 1112 is about 30 cm, the length of the outer cover is about 40 cm, and the radius of curvature of the round part 1608 of cover 1604 is about 5 cm. The length of the cover may extend beyond the length of the detector, for example, to allow accommodation of electronics, encoders, and/or proximity sensors (all not shown).

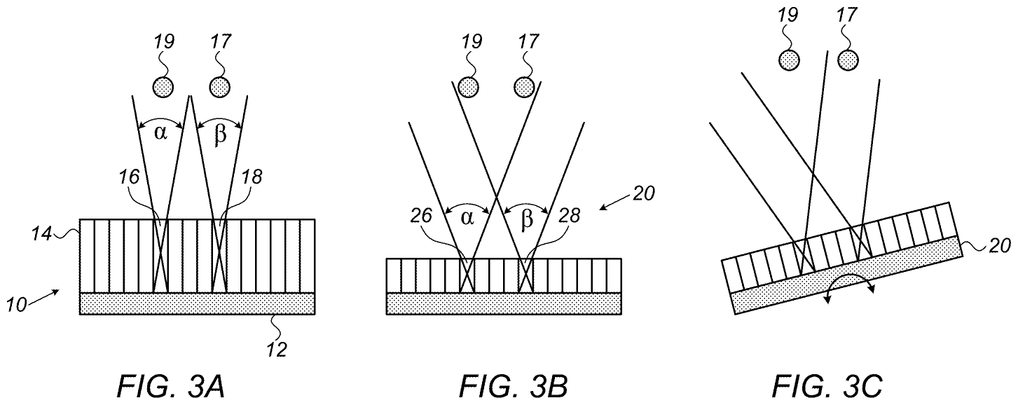

FIGS. 3A to 3C illustrate how the resolution in SPECT may be dominated by the distance from the collimator, the collimator's geometry, and the swivel angle.

FIG. 3A is a diagrammatic representation of a detector 10 having a detection layer 12 and septa 14 perpendicular to the detection layer. Also illustrated in the figure are two solid angles (α and β). Solid angle α illustrates the region from which photons may reach the part of the detection layer 12 that is directly below opening 16 between two septa. Similarly, Solid angle β illustrates the region from which photons may reach the part of the detection layer 12 that is directly below opening 18 between two septa. In the situation illustrated in FIG. 3A, each of the photons 17 and 19 will hit detection layer 12 at a different part thereof, and thus, may be distinguished during reconstruction, leading to a certain resolution level. FIG. 3B illustrates a situation where the resolution level is lower.

FIG. 3A also illustrates that the resolution decreases when the distance from the collimator increases. This general feature causes differences in resolution of the same point when imaged from different distances, as may be the case, for example, when radiation from a point is detected by detector(s) at two configurations that differ from each other in the distance from that point. In such a case, in the direction where the detector was close to the point the resolution is better than in the direction where the detector was far from the point. This mechanism may cause images imaged with an imaging system like that of FIG. 1 to have points, each having different resolutions along different directions, and also having different resolutions along a given direction, between points that are at different distances from a detector.

In FIG. 3B, detector 20 has shorter septa than detector 10. As a result, the photons 17 and 19 may reach with equal probability parts of detector layer 12 that are opposite openings 26 and 28. This will result in lower resolution than the one achieved by the detector illustrated in FIG. 2A.

In the situation illustrated in FIG. 3C, detector 20 (which is identical to detector 20 of FIG. 3B) may distinguish between photons 17 and 19 due to its tilt, obtainable by swiveling. Thus, FIGS. 3A, 3B, and 3C together illustrate how the resolution level may depend upon the swivel angle (optionally in combination with the collimator structure).

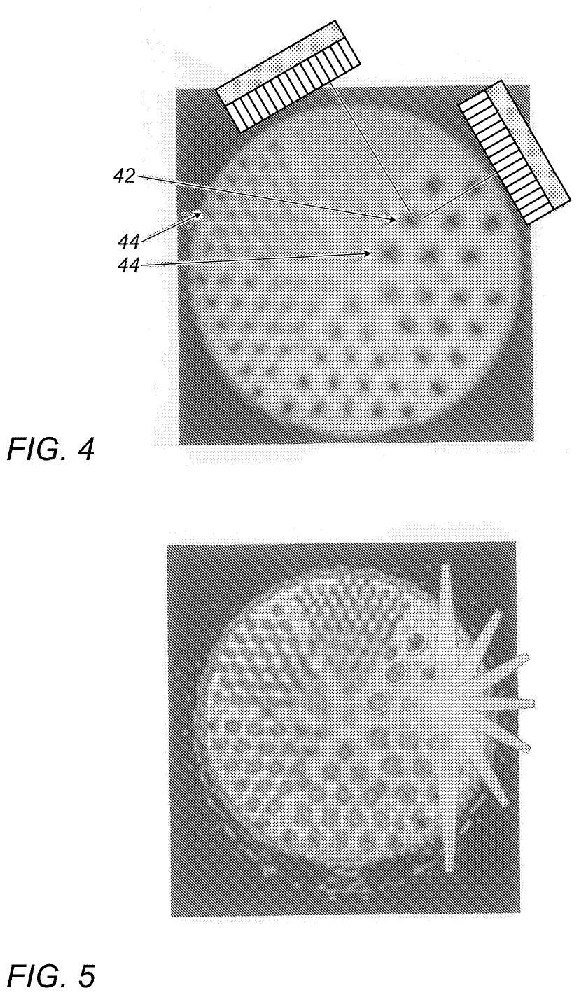

FIG. 4 is a copy of a SPECT image taken from a Jaszczak SPECT Phantom by a system similar to that illustrated in FIG. 1, but without correcting the local resolutions as taught herein. FIG. 4 shows that some rods in the phantom are imaged round, and some are imaged elliptical. For example, rod 42 is imaged elliptical and each of rods 44 is imaged round. This difference in shape may be explained by differences in the detector configurations by which different points are imaged. For example, elliptical rod 42 is imaged by two detectors from different distances, so that the resolution in its vicinity is different along different directions; a situation expressed in the rod image being elliptical. Rods imaged by detectors similarly distanced from the point, on the other hand, tend to be imaged round. Some embodiments of the present invention may correct the image, so that all the rods are round, or at least less elliptical, or equally elliptical throughout the image.

In some embodiments, the system scan pattern (that is, at what detector configurations each detector was during the imaging, for what time duration, with what kind of collimator, etc.) is used to estimate the resolution at each pixel within the image, by considering the distance and orientation of all detector positions during the scan with respect to the pixel location. The system scan pattern may also be used to estimate the expected noise at each location. See FIG. 5 for an illustration of the resolution estimation process. As illustrated in FIG. 5, the resolution of a point along each direction is estimated based on the distance between the point and the detectors detecting radiation from the point, at different detector configurations.

Once the resolution is estimated for each pixel location, this information can be used in multiple ways. One way to use this information is to construct a linear spatial-varying smoothing operator, which performs locally variant smoothing. The smoothing may be performed such that higher resolution locations are smoothed to a larger extent than low resolution locations, and the smoothing operation is optionally carried out perpendicularly to the direction with the higher resolution. This type of smoothing, although only capable of reducing image resolution, significantly decreases the negative psycho-visual effect caused by the variable and directional image resolution.

An effect of such smoothing may be illustrated by comparing FIG. 6A (before smoothing) to FIG. 6B (after smoothing). Both images are generated from the same brain acquisition. It can be seen that the central structures are maintained by the smoothing, and the peripheral directionality eliminated.

A linear operator is just one example of using the variable resolution information. It may be incorporated, in a similar way, into non-linear operators. Another option is to use the spatial information for regularization term within an iterative tomographic reconstruction process.

In the following it is assumed that a spatial-varying smoothing operator (in either a linear or non-linear form) is given, and denoted as Z(I), where I is a given input image.

One way of using the operator Z(I) is applying it after the reconstruction process. A result of this is displayed in 6B.

Alternatively or additionally, Z(I) may be incorporated into the tomographic reconstruction process that reconstructs the image from the data collected by the gamma detectors. For example, the reconstruction can be implemented by the following iterative process, known as Maximum Likelihood Expectation Maximization (MLEM)

$${I}_{k + 1} = {I}_{k} \cdot \frac{{A}^{T} ( \frac{Y}{{AI}_{k}} )}{{A}^{T} {1}_{np}}$$

Where
Y denotes the measured projections
Iₖ denotes the reconstructed image estimate at iteration k
A is an nₚ×nᵥ matrix, which denotes the forward imaging model, assumed to be linear, where nₚ is the number of measurements and nᵥ is the number of voxels in the reconstructed image.

In some embodiments, a Maximum A-posteriori (MAP) iteration may be carried out. One possibility for implementing a MAP iteration with the spatial-varying smoothing operator Z(I) is as follows:

$${I}_{k + 1} = {I}_{k} \cdot \frac{{A}^{T} ( \frac{Y}{{AI}_{k}} )}{{A}^{T} {1}_{np} + β \cdot \frac{{I}_{k} - Z ( {I}_{k} )}{Z ( {I}_{k} )}}$$

Where β is a hyper parameter (e.g. a user defined parameter) which controls the degree of regularization and Z(Iₖ) may be any operator applied to the image, and in particular, the above mentioned spatial-varying smoothing operator.

A simpler, yet effective option for regularization would be to apply the operator between iterations, e.g.,

$${I}_{k + 1} = Z ( {I}_{k} \cdot \frac{{A}^{T} ( \frac{Y}{{AI}_{k}} )}{{A}^{T} {1}_{np}} )$$

In order to control the degree of regularization, a weighted average between the filtered and non-filtered estimate may be carried out, for example:

$${\hat{I}}_{k + 1} = {I}_{k} \cdot \frac{{A}^{T} ( \frac{Y}{{AI}_{k}} )}{{A}^{T} {1}_{np}} , {I}_{k + 1} = α \cdot Z ( {\hat{I}}_{k + 1} ) + ( 1 - α ) \cdot {\hat{I}}_{k + 1}$$

Where α is a hyper parameter which controls the degree of regularization.

It is expected that during the life of a patent maturing from this application many relevant methods for scanning a region of interest by one or more gamma detectors will be developed; the scope of the term scanning a region of interest by gamma detector(s) is intended to include all such new technologies a priori.

As used herein with reference to quantity or value, the term “about” means “within ±10% of”.

The word “exemplary” is used herein to mean “serving as an example”, and not necessarily as “extremely good”.

The terms “high” and “low” are used to indicate that the “high” is higher than the “low”. Similarly, the terms “higher” and “lower” are used herein to mean higher than the one referred to as “lower”, and lower than the one referred to “higher”, respectively.

The terms “comprises”, “comprising”, “includes”, “including”, “has”, “having” and their conjugates mean “including but not limited to”.

As used herein, the singular forms “a”, “an” and “the” include plural references unless the context clearly dictates otherwise. For example, the term “a processor” or “at least one processor” may include a plurality of processors, packaged together or separately.

Throughout this application, embodiments of this invention may be presented with reference to a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as “from 1 to 6” should be considered to have specifically disclosed subranges such as “from 1 to 3”, “from 1 to 4”, “from 1 to 5”, “from 2 to 4”, “from 2 to 6”, “from 3 to 6”, etc.; as well as individual numbers within that range, for example, 1, 2, 3, 4, 5, and 6. This applies regardless of the breadth of the range.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween.

Unless otherwise indicated, numbers used herein and any number ranges based thereon are approximations within the accuracy of reasonable measurement and rounding errors as understood by persons skilled in the art.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of processing a SPECT image of a region of interest obtained using at least one gamma detector detecting gamma radiation from the region of interest at multiple detector configurations, the method comprising:
obtaining data indicative of the detector configurations and their spatial relationships to the region of interest;
determining a resolution level for each of a plurality of directions in each point in the image based on the data obtained; and
processing the image based on the resolution levels determined.

2. The method of claim 1, wherein the data is further indicative of multiple detection durations, each associated with at least one of the detector configurations, and wherein the resolution levels are determined based on said durations.

3. The method of claim 1, wherein the resolution levels are described by an estimated point spread function (PSF) at each point location.

4. The method of claim 1, wherein for at least one point, different resolution levels are determined along different directions.

5. The method of claim 1, wherein the data is further indicative of the shape of the region of interest, and the resolution levels are determined based on said shape.

6. The method of claim 1, wherein the processing comprises reducing the variability of a point resolution along different directions.

7. The method of claim 1, wherein the processing comprises reducing the variability of a direction resolution among different points.

8. The method of claim 1, wherein the processing comprises reducing the variability of local resolutions along different points in the image.

9. The method of claim 1, wherein processing the image comprises reducing the resolution in a first direction of a point having in the first direction a resolution level higher than in a second direction.

10. The method of claim 1, comprising denoising the image based on the resolution levels determined.

11. The method of claim 1, comprising sharpening the image based on the resolution levels determined.

12. The method of claim 1, comprising reducing the resolution in some points and/or directions and sharpening the image in other points and/or directions.

13.-22. (canceled)

23. An apparatus for imaging a region of interest, the apparatus comprising:
at least one gamma detector;
a detection controller configured to control the at least one gamma detector to detect gamma radiation from the region of interest at multiple detector configurations; and
a processor configured to
reconstruct an image from readings of the at least one gamma detector;
obtain data indicative of the multiple detector configurations and their spatial relationships to the region of interest;
determine a resolution level for each of a plurality of directions in each point in the image based on the data obtained; and
process the image based on the resolution levels determined.

24. The apparatus of claim 23, wherein the detection controller is configured to control the at least one gamma detector to detect gamma radiation from the region of interest for a different time duration at each of the multiple detector configurations, and wherein the resolution levels are determined based on said time durations.

25. The apparatus of claim 23, wherein the data is further indicative of the shape of the region of interest, and the resolution levels are determined based on said shape.

26. The apparatus of claim 25, further comprising at least one 3D sensor, and the processor is configured to infer the shape of the region from readings of the at least one 3D sensor.

27. The apparatus of claim 23, wherein the processor is configured to process the image so that a variability of a point resolution along different directions is reduced.

28. The apparatus of claim 23, wherein the processor is configured to process the image so that a variability of a direction resolution among different points is reduced.

29. The apparatus of claim 23, wherein the processor is configured to process the image by reducing the resolution of a point along the first direction for points having a resolution level higher in the first direction than in a second direction.

30. The apparatus of claim 23, wherein the processor is configured to reconstruct a denoised image based on the resolution levels determined.

31. The apparatus of claim 23, wherein the processor is configured to reconstruct a sharpened image based on the resolution levels determined.
